(19) United States
(12) Patent Application Publication
(10) Pub. No.: US 2011/0135075 A1
(43) Pub. Date: Jun. 9, 2011

(54) METHOD AND SYSTEM FOR PROVIDING CALLER IDENTIFICATION BASED MESSAGING SERVICES

(75) Inventors: Paul V. Hubner, McKinney, TX (US); Steven T. Archer, Dallas, TX (US); Robert A. Clavenna, Lucas, TX (US); Kristopher A. Pate, Sachse, TX (US)

(73) Assignee: VERIZON PATENT AND LICENSING INC., Basking Ridge, NJ (US)

(21) Appl. No.: 12/634,421

(22) Filed: Dec. 9, 2009

(51) Int. Cl. H04M 15/06

(52) U.S. Cl. 379/142.04

(57) ABSTRACT

An approach provides caller identification-based messaging services. A user-defined message associated with a directory address of a communication device is received. The user-defined message is inserted into a caller identification field of a caller identification message. Establishment of a communication session is initiated with the communication device. The caller identification message is transmitted to the communication device for presentation of the user-defined message during establishment of the communication session.

### BACKGROUND INFORMATION

The telecommunication industry offers customers a wide variety of telephony services via legacy circuit-switched networks, such as caller identification (or caller ID) services. Caller ID services enable called parties to receive information relating to the source of a communication session before “picking up,” or otherwise answering, the communication session. In this manner, when a communication session is terminated at a communication device of a called party, the communication device (or a display device associated therewith) may receive and present caller ID information, such as calling number (CNUM) information and/or calling name (CNAM) information, associated with a communication device of a calling party. Traditionally, caller ID information has conveyed no other information. With the advent of packet-switched networks supporting, for instance, internet protocol based services, an increasing number of consumers have been migrating from the use of traditional communication based technologies to synergistic communication based platforms, as well as to converged infrastructures, such as legacy circuit-switched networks converged with packet-switched networks, wired networks converged with wireless networks, and the like. Even though the telecommunication industry has embraced this convergence, the development of new products and services, e.g., messaging services, has been skewed towards the packet-switched domains, despite the large installed base of plain old telephone service (POTS) customers.

Therefore, there is a need for an approach that provides messaging services over legacy infrastructures.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system configured to provide caller identification-based messaging services, according to an exemplary embodiment;

FIG. 2 is a diagram of a regional infrastructure configured to provide caller identification-based messaging services, according to an exemplary embodiment;

FIG. 3 is a diagram of a communication session control node configured to facilitate caller identification-based messaging services, according to an exemplary embodiment;

FIG. 4 is a flowchart of a process for generating a caller identification-based messaging profile, according to an exemplary embodiment;

FIG. 5 is a flowchart of a process for receiving and storing caller identification-based message content, according to an exemplary embodiment;

FIG. 6 is a diagram of user-defined message content stored in association with one or more messaging attributes, according to an exemplary embodiment;

FIG. 7 is a flowchart of a process for providing caller identification-based messages to subscribers, according to an exemplary embodiment;

FIG. 8 is a diagram of a caller identification-based message, according to an exemplary embodiment;

FIG. 9 is a flowchart of a process for presenting caller identification-based messages, according to an exemplary embodiment;

FIG. 10 is a diagram of a caller identification-based message presented via a conventional caller identification interface, according to an exemplary embodiment; and

FIG. 11 is a diagram of a computer system that can be used to implement various exemplary embodiments.

### DESCRIPTION OF THE PREFERRED EMBODIMENT

A preferred apparatus, method, and software for providing caller identification-based messaging services are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to certain telephony networks, protocols, and technologies, it is contemplated that various exemplary embodiments are also applicable to other similar and/or equivalent networks, protocols, and technologies.

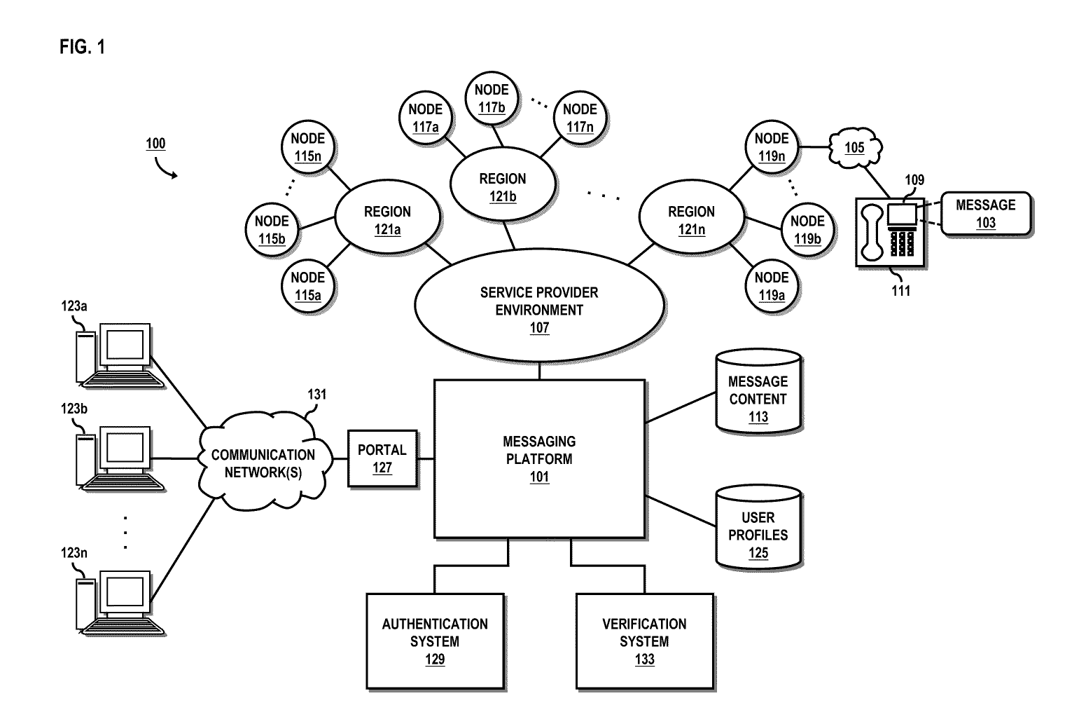

FIG. 1 is a diagram of a system configured to provide caller identification-based messaging services, according to an exemplary embodiment. For the purposes of illustration, system 100 is described with respect to messaging platform (or platform) 101 that is configured to enable a first category of users (or subscribers) to establish one or more caller identification (or caller ID)-based messaging profiles to govern the reception of caller ID-based messages (e.g., message 103) over one or more telephony access networks 105 associated with service provider environment 107. These caller ID-based messages may be presented to users via conventional caller ID interfaces (e.g., caller ID interface 109) of or associated with respective communication devices 111 during establishment of corresponding communication sessions with communication devices 111, such as, for example, before, during, or after a predetermined number of alerting signals (whether audible, visual, and/or tactile) have been presented in association with the establishment of the corresponding communication sessions. In exemplary embodiments, these caller ID-based messages may be configured to override caller ID information stored to (or in association with) communication devices 111. By way of example, service provider environment 107 may correspond to a data, voice, and/or video infrastructure of a service provider in support of one or more telephony services. As such, platform 101 may also be configured to permit a second category of users to create and/or upload messaging content to one or more message content repositories, such as message content repository 113. In this manner, one or more communication session control nodes (such as communication session control nodes 115a-115n, 117a-117n, and 119a-119n associated with regions 121a-121n of service provider environment 107) may be configured to receive and/or retrieve user-defined message content stored to, for instance, message content repository 113 and, thereby, transmit the user-defined message content to corresponding communication devices 111 for presentation via conventional caller ID interfaces 109 during establishment of the corresponding communication sessions. While specific reference will be made hereto, it is contemplated that system 100 may embody many forms and include multiple and/or alternative components and facilities.

As previously mentioned, caller identification (or caller ID) is a telephony service configured to provide subscribers with identification information about a party attempting to initiate communication with the subscribers, such as calling number (CNUM) information and/or calling name (CNAM) information. Typically, CNUM and/or CNAM information is transmitted to a subscriber for presentation on a display of (or associated with) a communication device during establishment of the communication session. For instance, caller ID information may be transmitted to the subscriber between a first and second signaling alert indicating an attempt to establish communications with the subscriber. Beyond presentation of CNUM and CNAM information, caller ID services may only further include date and time information, but has traditionally provided no other information, nor is utilized for other uses. It is also recognized that messaging services, such as short text messaging services, have been primarily limited to packet-switched domains. Given the large installed base of circuit-switched telephony users and infrastructures, a large existing segment of circuit-switched telephony users have yet to receive the benefits of messaging services.

Therefore, the approach according to certain exemplary embodiments of system 100 stems from the recognition that providing caller ID-based messaging services, whereby a first category of subscribers can create and configure caller ID-based messaging profiles for receiving caller ID based messages and a second category of subscribers can create and/or upload messaging content to be conveyed to the first category of subscribers via caller ID-based messages, provides an efficient and convenient technique to “push” message content and/or information to circuit-switched telephony users during establishment of a communication session, as well as enables service providers to harness technological synergies through the strategic leveraging of existing infrastructures in innovative, unconventional manners. This approach further stems from the recognition that the extension of messaging services over legacy infrastructures by way of conventional caller ID-interfaces affords service providers a unique opportunity to not only generate new sources of revenue with existing infrastructures, protocols, and technologies, but enables service providers to access untapped consumer market segments and potentially divert some short messaging service traffic from congesting packet-switched networks onto circuit-switched networks. Accordingly, certain other exemplary embodiments stem from the recognition by conveying user-defined messaging content to subscribers via one or more fields of existing caller ID interfaces (e.g., one or more CNAM, CNUM, etc., caller ID fields), consumers and service providers need not require extensive upgrades to realize the vast benefits of such messaging services.

In exemplary embodiments, system 100 facilitates caller ID-based messaging services by enabling a first category of users (or subscribers), e.g., caller ID-based message receivers, to access platform 101 via one or more user devices 123a-123n to register to the caller ID-based messaging services of system 100, as well as to create, customize, and manage one or more user profiles stored to, for example, user profiles repository 125. These user profiles may include one or more user-defined caller ID-based messaging profiles (or policies) enabling subscribers to opt-in and out of receiving caller ID-based messages from various message content providers, such as a service provider of system 100 and/or one or more third-party message content providers, which may include conventional consumers. It is noted that these user-defined caller ID-based messaging policies may further include one or more parameters (or criteria) governing the “who,” “what,” “when,” “where,” and “how” caller ID-based messages are to be received, such as various parameters defining amount (e.g., certain number of messages per hour, day, week, etc.), frequency of presentation (e.g., continuously, periodically, on-demand, etc.), marketplaces (e.g., basic materials, capital goods, energy, financial, healthcare, services, technology, transportation, utilities, etc.), etc., for receiving caller ID-based messages, such as message 103. In certain embodiments, the user-defined messaging policies may include other suitable criteria, such as one or more “whitelists” specifying permissible message content providers, message content, and the like, that may be received or targeted to the users and one or more “blacklists” specifying impermissible (or objectionable) message content providers, message content, etc., that should not be received or targeted to the users.

According to various exemplary embodiments, these parameters, criteria, etc., may be utilized by one or more communication session control nodes 115a-119n to receive, retrieve, select, and transmit caller ID-based messages and/or or caller ID-based message content to users associated with communication devices 111. As such, users may be enabled to generate user profiles including other information related to the subscribers, such as user profile information defining subscription information (e.g., account numbers, usernames, passwords, security questions, monikers, circuit identification (ID), private virtual connection (PVC) ID, virtual local area network (VLAN) ID, etc.), subscriber demographics, location (e.g., spatial positioning, latitude, longitude, elevation, etc.), group/organizational affiliations, memberships, interests, buddies, friends, cohorts, associated users/devices, etc., as well as any other like personal information. It is noted that any of the aforementioned (or other suitable) user profile information may be utilized to target caller ID-based message content to subscribers of certain interests and, as a result, caller ID-based message receiving parties may also be permitted to define boundaries for the use and/or dissemination of their user profile information, whether in connection with receiving caller ID-based messages or associated with another purpose.

Similarly, a second category of users (or subscribers), e.g., message content providers, may also have access to platform 101 via one or more user devices 123a-123n. As such, these users may register to the caller ID-based messaging services of system 100, as well as create, customize, and manage one or more user profiles including, for example, scheduling information (e.g., dates, times, events, circumstances, etc.) for responding to queries for (or providing) caller ID-based message content to one or more of communication session control nodes 115a-119n for transmission to communication devices 111 during establishment of corresponding communication sessions with respective communication devices 111. It is noted that these user profiles may include other user profile information, such as username, password, account information, billing information, configuration information, description, address, hours of operation, product/service offering(s), product/service price(s), helpdesk information, contact addresses, menus, catalogues, and the like. It is further noted these users may be provided access to platform 101 to store and manage user-defined message content to message content repository 113. In this manner, messaging parties can not only provide user-defined messages to the first category of users via caller ID-based interfaces, but may also specify times and circumstances under which particular user-defined messages are to be selected for transmission to communication devices 111 during establishment of corresponding communication sessions with respective communication devices 111. In additional (or alternative) embodiments, user preference and/or profile information can be used to select user-defined messages for transmission to communication devices 111.

According to particular embodiments, users may access platform 101 via portal 127, which may be configured as a voice portal or a web portal. In one embodiment, a networked application for implementing portal 127 may be deployed via platform 101; however, it is contemplated that another facility or component of system 100, such as a frontend, middleware, or backend server, may deploy a portal application and, consequently, interface with messaging platform 101. In this manner, portal 127 may include or provide users with the ability to access, configure, manage, and store user profiles to, for example, user profiles repository 125 or any other suitable storage location or memory of (or accessible to) platform 101. Likewise, portal 127 may include or provide users with the ability to access, configure, manage, and store message content to, for example, message content repository 113 or any other suitable storage location or memory of (or accessible to) platform 101. As such, portal 127 enables users to provide corresponding authentication information, which may be verified via authentication system 129, and, subsequently, create, customize, and manage one or more user profiles and/or message content via one or more user interfaces, e.g., graphical user interfaces (GUI), implemented via portal 127, platform 101, user devices 123a-123n, etc.

According to various embodiments, platform 101 may be implemented in one or more computing environments, including as a backend component (e.g., as a data server), as a middleware component (e.g., as an application server), as a front-end component (e.g., as a client computing device having a GUI or web-browsing application through which client computing devices can interact with a data server or application server), or as any combination thereof. Platform 101 may be interconnected by any form or medium capable of supporting data communications, such as one or more communication networks 131, e.g., a local area network (LAN), a metropolitan area network (MAN), a wide area network (WAN), the Internet, and/or the like. Further, communication networks 131 may embody various circuit-switched, packet-switched, and/or wireless networks capable of transmitting data (or other information), such as transmitting data between user devices 123a-123n and platform 101. As such, system 100 may embody a client-server environment, a master-slave environment, a peer-to-peer environment, or any other suitable environment. Although depicted as separate entities, communication network(s) 131 may be completely or partially contained within service provider environment 107. For example, communication networks 131 may include facilities to provide for transport of packet-based and/or telephony communications within service provider environment 107.

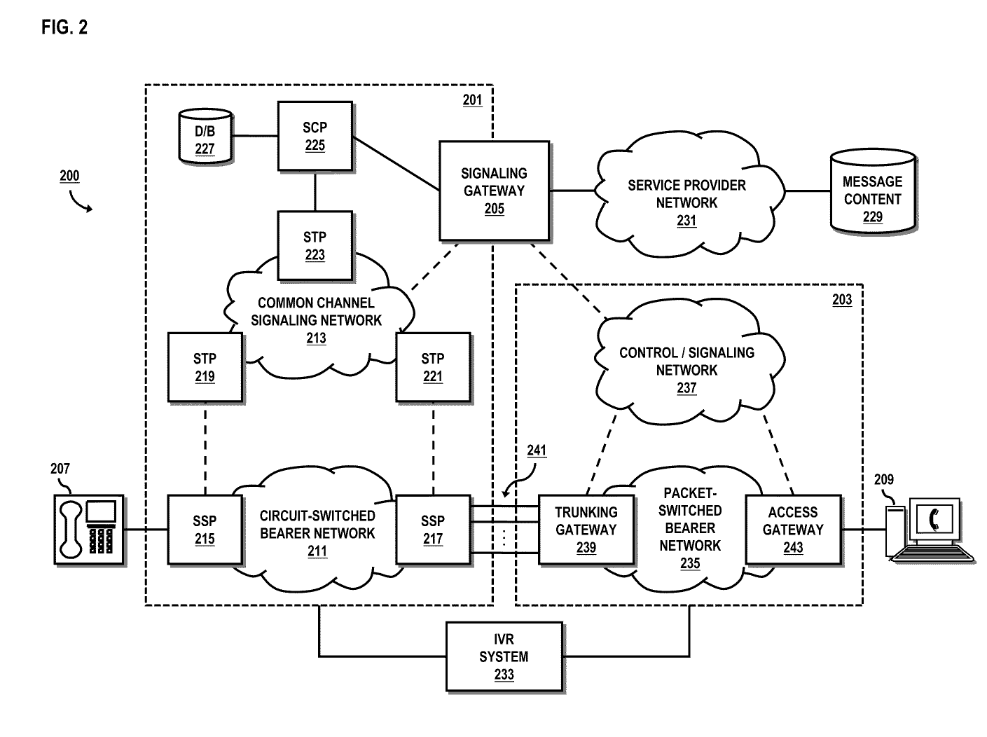

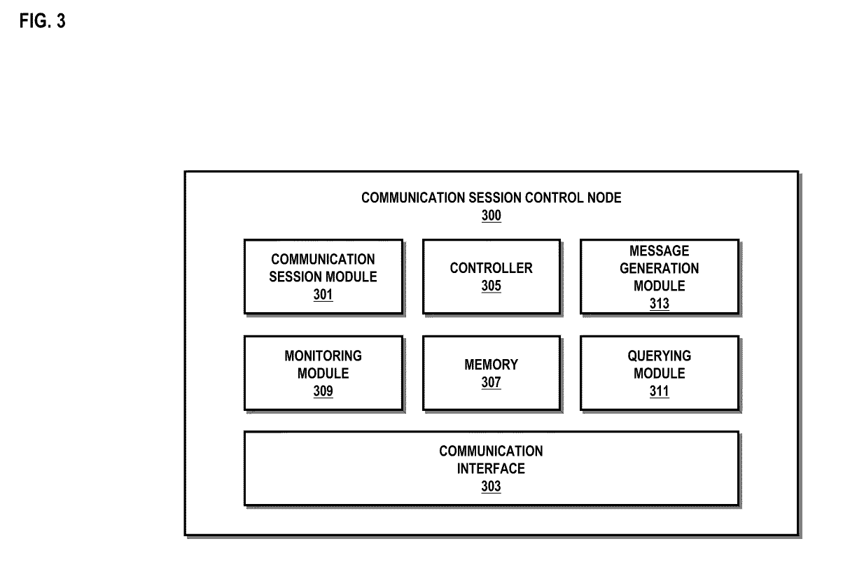

In exemplary embodiments, service provider environment 107 may be any network (or group of networks) through which users (such as home users, business users, and the like) communicate with various service providers and/or other users. As such, service provider environment 107 may include various facilities and equipment that extend from the location(s) of each user to the location(s) of the service provider in order to facilitate communications therebetween. For instance, service provider environment 107 may include the outside plant, the inside plant, and/or the inside wiring of a service provider. By way of example, the outside plant includes the cables, conduits, ducts, poles, and other supporting structures, as well as certain equipment items, such as load coils, repeaters, etc. Namely, the outside plant includes the local loops, which are the physical connections from one or more customer premises (e.g., residential homes, commercial businesses, etc.) to the points of presence (POP) of the service provider. It is noted that the local loops may be provided over any suitable transmission medium, including twisted pair, fiber optic, coax, and the like. For example, a local loop of a conventional telephone system may comprise twisted pairs (or other wiring) that connect a demarcation point (e.g., a distribution frame, a cable head, etc.) of a customer premise to an edge (e.g., a circuit switch) of a local exchange carrier (LEC) central office (CO). The inside plant may include the fixtures, implements, machinery, and apparatuses used within one or more COs of the service provider, such as the switches, routers, broadband equipment, distribution frames, transmission equipment, power supply equipment, heat coil protectors, grounding systems, etc., of the service provider. Accordingly, the inside wiring includes the aforementioned transmission mediums as those mediums are located within a customer premise or building. The inside wiring begins at the demarcation point and extends to individual end terminals, such as one or more user devices 123a-123n and user communication devices 111. In this manner, service provider environment 107 may be geographically dispersed across numerous regions 121a-121n and/or logically divided according to other (or additional) schemes. An exemplary region of service provider environment 107 is described in more detail with FIG. 2. It is noted, however, that regions 121a-121n may include one or more communication session control nodes (e.g., communication session control nodes 115a-119n) for transmitting (e.g., “pushing”) caller ID-based messages (e.g., message 103) to corresponding communication devices 111 during establishment of communication sessions with communication devices 111 based on information (e.g., user-defined messages) received and/or retrieved from one or more message content repositories, such as message content repository 113. Communication session control nodes 115a-119n are described in more detail in association with FIGS. 2 and 3.

FIG. 2 is a diagram of a regional infrastructure configured to provide caller identification-based messaging services, according to an exemplary embodiment. Regional infrastructure (or region) 200 includes at least one telephony network, such as a legacy circuit-switched network 201. In certain implementations, however, region 200 may also include one or more other networks configured to provide telephony services, such as one or more packet-switched networks 203, one or more wireless telephony networks (not illustrated), etc. As shown in FIG. 2, circuit-switched network 201 is interworked (or otherwise interconnected) with packet-switched network 203 via one or more signaling gateways 205 that, in exemplary embodiments, may serve as a communication session control node for establishing communication sessions with one or more communication devices (e.g., communication devices 207 and 209), such as, for the purpose of, “pushing” or otherwise transmitting caller ID-based messages to communication devices 207 and 209 during establishment of corresponding communication sessions with communication devices 207 and 209. In this example, circuit-switched network 201 may be configured to employ suitable multiplexing techniques or transmission protocols, such as frequency division multiplexing (FDM), time division multiplexing (TDM), wavelength division multiplexing (WDM), and the like, whereas packet-switched network 203 may utilize other transmission protocols, such as internet protocol (IP), asynchronous transfer mode (ATM), frame relay, and the like, for establishing communication sessions with communication devices 207 and 209. As such, circuit-switched telephony network 201 may be configured to provide legacy analog telephony services, whereas packet-switched network 203 may be configured to provide various digital telephony services, such as one or more “voice over” telephony services, e.g., voice over IP, voice over ATM, voice over frame relay, etc., telephony services.

According to exemplary embodiments, circuit-switched network 201 includes circuit-switched bearer network 211 and common channel signaling network 213 for facilitating communication sessions. Circuit-switched bearer network 211 includes various switching nodes, such as one or more service switching points (SSP), e.g., SSPs 215 and 217, that are interconnected via one or more trunks (or transmission channels) that are configured to transport network traffic from originating devices to terminating devices, such as between communication devices 207 and 209. Common channel signaling network 213 is, for instance, an SS7 signaling network configured to facilitate control signaling between switching nodes of circuit-switched bearer network 211, e.g., SSPs 215 and 217, signaling transfer points (STPs) 219, 221, and 223, and service control points (SCPs) 225. It is noted that each of the SSPs, STPs, and SCPs embodying circuit-switched network 201 may be uniquely identified by, for instance, corresponding point codes (PC), whereas the various transmission channels of the trunks of circuit-switched network 201 may be identified by, for example, corresponding circuit identification codes (CIC). Further, communication devices 207 and 209 may be identified by unique directory addresses.

Service switching points 215 and 217 may be, for instance, class-5 type central office (CO) switches (e.g., local exchange carriers) connected to common channel signaling network 213 via STPs 219 and 221, respectively. In order to enable communications to be routed over circuit-switched bearer network 211, SSPs 215 and 217 are interconnected via one or more trunks, whereas SSPs 215 and 217 are respectively interconnected to STPs 219 and 221 via either one or more direct (e.g., associated signaling) or indirect (e.g., quasi-associated signaling) links or link sets. Intelligent or otherwise extended services may be provided by one or more signaling gateways 205 and/or one or more SCPs 225 that maintain profile information (such as calling code information, directory address information, billing information, and the like) in one or more repositories 227. This profile information may be utilized to set up, tear down, and manage communication sessions, as well as effectuate one or more other services, such as the caller ID-based messaging services of system 100. Even though not illustrated, signaling gateways 205 and SCPs 225 may further communicate with one or more intelligent peripherals to enable voice messaging services, communication session forwarding, and the like. In this manner, signaling gateways 205 and/or SCPs 225 may be configured (alone or in conjunction with one or more intelligent peripherals) to query one or more networked repositories, such as message content repository 229 over one or more service provider networks 231, and/or connect one or more interactive response (IVR) systems 233 to “staffed” or otherwise answered communication sessions.

Signal transfer points 219, 221, and 223 may be configured to pass and/or route signaling messages between SSPs 215 and 217, other STPs (not shown), SCPs 225, and/or signaling gateways 205. Accordingly, information extracted from one or more addressing fields of these signaling messages may be utilized by SSPs 215 and 217 to route communications between corresponding endpoints, such as between signaling gateway(s) 205 and SCP(s) 225 and communication devices 207 and 209. It is also noted that signaling messages may be exchanged by nodes of common channel signaling network (e.g., STPs 219, 221, and 223) to “learn” about the operating state of common channel signaling network 213, such as to ascertain the availability of adjacent or other STPs, determine bit error rates on particular signaling links, inform adjacent or other STPs that certain STPs are (or are going) out of service, etc. According to exemplary embodiments, these signaling messages may also be utilized by STPs 219-223 and/or SSPs 215 and 217 to transmit caller ID-based messages to communication devices 207 and 209. These caller ID messages may include (or otherwise embody) one or more fields, such as a caller name identification (CNAM) field and a caller number identification (CNUM).

Packet-switched network 203 includes packet-switched bearer network 235 and control/signaling network 237, which may be a control/signaling plane of packet-switched bearer network 235. One or more trunking (or media) gateways 239 may be configured to enable dissimilar telecommunication networks, such as circuit switched network 201 and packet-switched network 203, to be interconnected via one or more inter-machine trunks (IMT) 241 that are each configured to support one or more transmission channels, such as for the exchange of information between nodes and/or endpoints respectively associated with circuit-switched network 201 and packet-switched network 203. Trunking gateways 239 may be controlled by one or more signaling gateways 205 via control/signaling network 237. In this manner, trunking gateways 239 enable user traffic to be interworked onto one or more pathways (not illustrated) of packet-switched bearer network 235. These pathways may be physical and/or logical links that terminate at, for instance, one or more access gateways 243 and, thereby, at one or more sockets of the access gateways 243. Access gateways 243 provide network connectivity to one or more communication devices, such as communication device 209. It is noted that circuit-switched network 201 and/or packet-switched network 203 may provide network connectivity to one or more IVR systems 233.

According to exemplary embodiments, signaling gateways 205 provide core communication session control functions and, thereby, are configured to exchange signaling traffic with one or more signaling nodes (e.g., STPs 219-223) of common channel signaling network 213 and one or more gateways (e.g., trunking gateway 239 and access gateway 243) of packet-switched bearer network 235. With respect to common channel signaling network 213, this signaling traffic may relate to, for instance, one or more SS7 integrated services digital network user part (ISUP) or telephone user part (TUP) signaling messages. Other common channel control protocols may include session initiation protocol (SIP), H.323, bearer independent call control (BICC), and the like. Control/signaling network 237 may, however, be configured to transport signaling traffic between signaling gateway 205 and, for instance, trunking gateway 239 and/or access gateway 243 in the form of one or more packets constructed utilizing, for example, internet protocol device control (IPDC) protocol. It is contemplated, however, that any other suitable packet-switched signaling protocol may be utilized, such as the network access server (NAS) protocol, media access gateway control protocol (MGCP), simple gateway control protocol (SGCP), H.218, and/or the like. As such, communication sessions (e.g., telephony calls) over circuit-switched network 201 may be setup via SS7 ISUP initial address messages (IAM) and torn down via release (REL) messages, whereas communication sessions over packet-switched network 203 may be setup via request connection between two endpoints (RCON) messages and torn down via release channel request (RCR) messages. Accordingly, signaling gateways 205 may be configured to convert between, for instance, the IAMs and RCON messages for communication session setup and between REL messages and RCR messages for communication session tear down. It is noted that ISUP messages and protocols are defined by Telecordia Technologies Specification of the Signaling System Number Seven, GR-246-CORE, Vol. 3, T1.113.1-T1.113.5, December 2001, which is incorporated, herein, by reference, in its entirety, whereas IPDC messages and protocols are defined by A. Dugan, IPDC Connection Control Protocol, Internet Engineering Task Force, August 1998, which is also incorporated, herein, by reference, in its entirety. It is noted that one or more CNAM and/or CNUM fields of IAM, RCON, REL, and RCR messages may be exchanged among and between signaling gateways 205, SSPs 215 and 217, STPs 219-223, SCPs 225, trunking gateways 239 and/or access gateways 243 in the process of conveying caller ID-based messages to communication devices 207 and 209 during establishment of corresponding communication sessions with communication devices 207 and 209, as will become more apparent below.

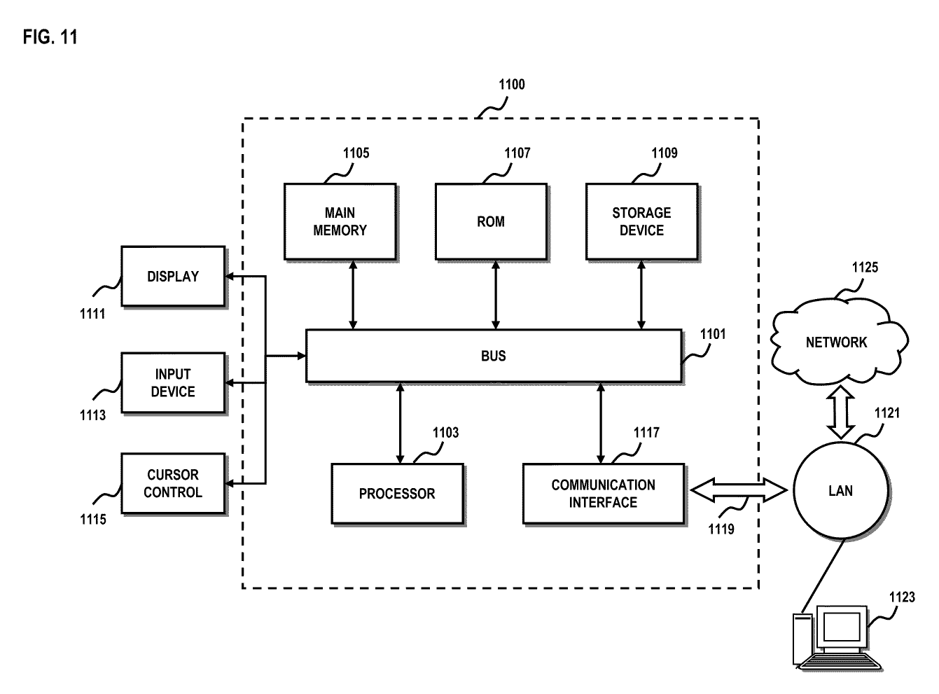

According to exemplary embodiments, signaling gateway(s) 205 and SCP(s) 225 are configured to function as communication session control nodes 115a-115n. FIG. 3 is a diagram of a communication session control node configured to facilitate caller identification-based messaging services, according to an exemplary embodiment. By way of example, communication session control node (or node) 300 may comprise computing hardware (such as described with respect to FIG. 11), as well as include one or more other components configured to execute the processes described herein. In one implementation, node 300 may be configured as a communication session signaling controller, such as signaling gateway 205 or signaling control point 225. As shown, node 300 includes communication session module 301, communication interface 303, controller (or processor) 305, memory 307, monitoring module 309, querying module 311, and message generation module 313. It is contemplated, however, that node 300 may embody many forms and include multiple and/or alternative components. For example, it is contemplated that the one or more components of node 300 may be combined, located in separate structures, and/or separate physical locations. In other words, a specific topology is not critical to embodiments of node 300.

According to exemplary embodiments, node 300 may include messaging logic or other computer program code stored to, for instance, memory 307 for causing node 300 to obtain (e.g., query for, retrieve, and/or receive) user-defined messages from one or more networked repositories, such as message content repository 229, via communication interface 303. These user-defined messages may be associated with one or more directory addresses that are, in turn, associated with subscribers opting to receive caller ID-based messages. As such, caller ID-based message content may be configured for various unicast, multicast, and/or broadcast purposes. For instance, this user-defined message content may include billing information, emergency information, flight information, group information, meeting information, weather information, stock information, sports information, notification information, news information, or any other suitable form of information, such as date and time information, etc.

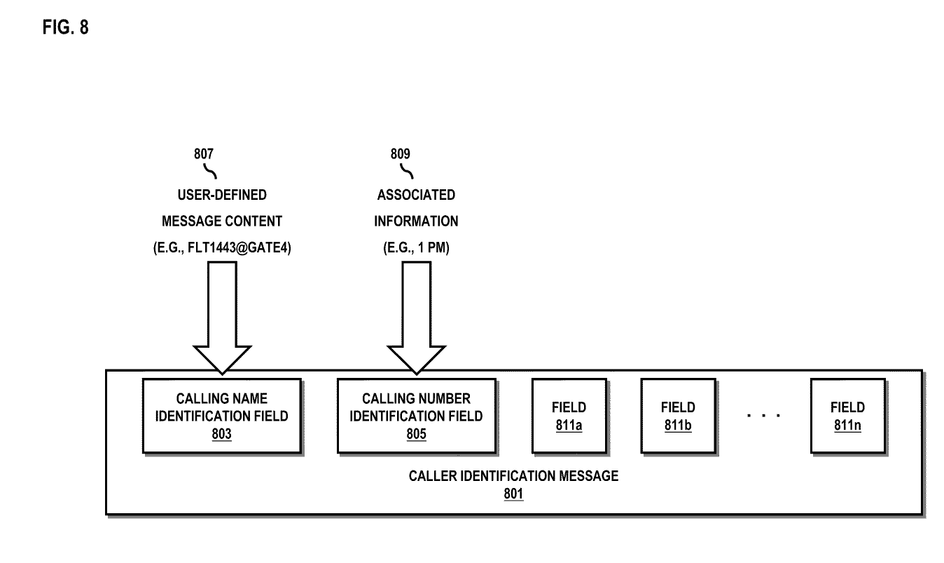

Querying module 311 may provide received user-defined message content to message generation module 313 for generating conventional caller ID-based messages having CNAM and CNUM fields. Instead of being populated with conventional CNAM and CNUM information, however, message generation module 313 may be configured to provide user-defined messages and/or other information associated with these user-defined messages in the conventional CNAM and CNUM fields. For instance, user-defined messages may be provided via CNAM fields, whereas associated user-defined information may be provided by CNUM fields. This may be more readily understood in conjunction with FIG. 8. As such, existing communication devices 111 having or being associated with display devices 109 for providing conventional caller ID telephony services may also be enabled to apprise themselves of the caller ID-based messaging services of system 100. This is because the caller ID-based messaging services provided by way of communication session module 301 are signaled to communication devices 111 by communication session module 301 and/or communication interface 303 using existing caller-ID technologies, infrastructures, and protocols, but unconventionally utilizing these resources for entirely unintended purposes, e.g., “pushing” user-defined messages to associated communication devices 111 during establishment of corresponding communication sessions with respective communication devices 111, such as, for example, before, during, or after a predetermined number of alerting signals (e.g., audible, visual, and/or tactile presentations) have been played out in association with the establishment of the communication sessions. Thus, node 300 may efficiently and effectively extend messaging services, e.g., short messaging services, over circuit-switched networking domains.

As mentioned, node 300 may be configured to “push” caller ID-based messages to communication devices 111 via, for example, communication session module 301 and/or communication interface 303. That is, the messaging logic or computer program code may be configured to cause node 300 to initiate establishment of a communication session with a corresponding communication device 111 for the purpose of transmitting user-defined message content received from, for example, message content repository 113 to, for instance, the communication device 111 during establishment of the communication session. It is noted that conventional caller ID telephony services require a communication session initiator (e.g., a calling party) to attempt to establish a communication session (e.g., a telephony call) with a communication session receiver (e.g., a called party) before traditional communication session control nodes provide caller ID information to the called party. As previously mentioned, node 300 is not so limited, however, node 300 via communication session module 301 may still provide caller ID-based messages according to conventional approaches in addition to approaches of various exemplary embodiments.

In certain embodiments, node 300 may be configured to transmit caller ID-based messages to intended recipients during establishment of a communication session. This transmission may occur before, during, or after one or more alerting intervals, whether audible, visual, or tactile. For instance, transmission may occur before, during, or after one or more “ringing tone” intervals, such as during a first “silent” interval after a first “ringing tone” interval have been played out in associated with the establishment of the communication session. As such, node 300 via communication session module 301 may be configured to cause one or more alerting signals to be presented at or by communication devices 111 during establishment of the communication session, so that caller ID-based messages may be presented via existing caller ID interfaces 109 of communication devices 111. Node 300 may also include monitoring module 309 to monitor and detect an “off hook” communication device status, i.e., a “staffed,” “picked up” or “answered” communication session state, for the purpose of connecting an interactive voice response (IVR) system (e.g., IVR system 233) to the communication session. These IVR systems 233 may be configured to present an audio or other voice portal interface for audibly conveying user-defined caller ID-based messages and/or user-defined information associated therewith, as well as for prompting and offering users options related to the user-defined messages and/or information. For instance, a user defined message may relate to a notification of an available phone bill requiring payment in a predefined time period. As such, if a subscriber were to answer a communication session utilized to push the notification to a communication device 111 associated with the subscriber during establishment of a communication session with communication device 111, communication session module 301 may connect the subscriber to an IVR system 233 configured to allow the subscriber to pay the bill, receive additional information, speak to a customer service representative, and/or execute or perform other like actions. This may be true for other forms of user-defined messages, such as flight information messages. In these instances, IVR systems 233 may allow users to confirm and/or modify flight reservations, purchase additional tickets, check-in early, etc. According to other embodiments, user-defined messages may include various advertisement information and IVR systems 233 may be utilized to provide additional information or allow subscribers to act on the received advertisement information. It is noted that these are only but a few of an endless array of user-defined messages and IVR system 233 configurations within the purview of exemplary embodiments and, as such, it is contemplated that exemplary embodiments are no so limited to these few examples.

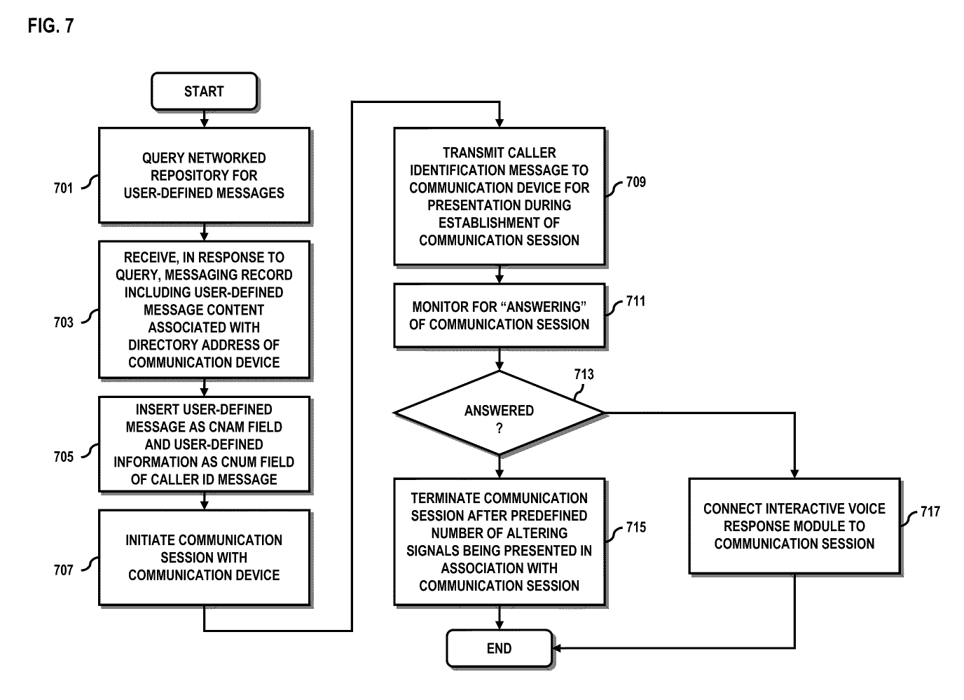

According to various other embodiments, monitoring module 309 may be configured to determine that an initiated communication session has not been staffed, picked up, or otherwise answered and, thereby, request communication session module 301 to terminate establishment of the communication session after a predefined number of alerting signals have been caused to be presented in association with the establishment of the communication session. For example, establishment of a communication session may be terminated by communication session module 301 after two or more ringing alerts have been caused to be presented by communication session module 301 in association with the establishment of the communication session with communication device 111. It is noted that an exemplary process for generating and transmitting caller ID-based messages to subscribers is described in more detail with FIG. 7.

Referring back to FIG. 1, platform 101 is implemented as a backend data server accessible to one or more user devices 123a-123n via a middleware application server, i.e., portal 127. As such, user devices 123a-123n may interact with portal 127 via one or more of communication networks 131. According to one embodiment, portal 127 is configured as an enterprise web portal that provides a consistent “look and feel” to various categories of users (or subscribers), such as message content providers and message content receivers, for access control to the features and functions of platform 101. In other instances, portal 127 may be additionally (or alternatively) configured as an enterprise web portal that provides a consistent “look and feel” for creating and managing one or more caller ID-based messaging profiles and/or creating, customizing, uploading, and/or managing messaging content stored to, for instance, message content repository 113. Such an architecture, while not necessary, enables user devices 123a-123n to be remotely dispersed (e.g., as by geography) from each other, as well as from platform 101, yet remain in collaboration with platform 101. Namely, portal 127 enables intelligent integration of and unified, real-time access to platform 101. According to one embodiment, portal 127 provides one or more customized portlets (e.g., user interface components) arranged in one or more page layouts, which can be tailored to the various categories of users and/or divisions (e.g., geographical regions 121a-121n) of service provider environment 107. Thus, users of like categories can be provided with common sets of web-based, or otherwise networked, caller ID-based messaging applications to consistently and efficiently manage the distribution and/or reception of caller ID-based messages (e.g., message 103) at communication devices 111. It is also contemplated that users may be provided with customized (e.g., user-customized) web-based or otherwise networked caller ID-based messaging applications to suit the eccentricities of individual users.

According to certain embodiments, platform 101 and/or portal 127 may communicate with verification system 133 in order to scan caller ID-based messaging content submitted by message content providers. For instance, verification system 133 may be configured to scan submitted user-defined messages for “objectionable” content, which may be statically and/or variably defined by one or more global policies of a service provider and/or one or more individual policies of receiving subscribers. As previously mentioned, these policies may include one or more parameters (or criteria) to control the who, what, when, where, and how caller ID-based messages are to be received. In this manner, verification system 133 may utilize information stored to one or more user profiles of, for example, user profiles repository 125 to determine and implement these policies. It is noted that, in other or additional instances, user-defined messaging content may be scanned against one or more technologically driven policies of existing telephony resources. For instance, certain existing common channel signaling networks, such as SS7 common channel signaling networks, are configured to transmit CNAM and CNUM information to communication devices 111 via frequency shift keyed (FSK) tones, which may then be presented to subscribers according to particular character-encoding schemes, such as an American Standard Code for Information Interchange (ASCII) character-encoding scheme. In this manner, user-defined messaging content may be scanned to ensure that the various characters (or glyphs) of these user-defined messages comply with the accepted “printable” characters of an implemented encoding scheme, such as scanned for compliance with the permissible letters, digits, punctuation marks, and/or other miscellaneous glyphs associated with an ASCII character-encoding scheme. It is also contemplated that submitted user-defined messages may be scanned for compliance with one or more CNAM and/or CNUM field constraints, such as for the purpose of limiting user-defined messages to a predefined maximum amount of characters, such as fifteen ASCII characters per CNAM and CNUM field.

System 100 may also include authentication system 129 for authenticating (or authorizing) users to the caller ID-based messaging services of system 100. For instance, authentication system 129 may operate in concert with platform 101 and/or portal 127 to verify user provided credential information against corresponding credential information stored to a user profile of user profiles repository 125. By way of example, this credential information may include “log on” information corresponding to a username, password, coded key, or other unique identification parameter, such a personal identification number (PIN). In other instances, credential information may include any one, or combination of, a birth date, an account number (e.g., bank, credit card, billing code, etc.), a social security number (SSN), an address (e.g., work, home, IP, media access control (MAC), etc.), or telephony listing (e.g., work, home, cellular, etc.), as well as any other form of uniquely identifiable datum, e.g., biometric code, voice print, etc. Users may provide this information via user deices 123a-123n, such as by spoken utterances, dual-tone multi-frequency signals (DTMF), packetized transmissions, etc. Unobtrusive security measures may be provided by positively identifying and screening users based on one or more of the aforementioned credentials which may be seamlessly provided when user devices 123a-123n communicate with platform 101, portal 127, or other component or facility of system 100, such as by providing a unique circuit-ID, PVC-ID, VLAN-ID, IP address, MAC address, etc. Other unobtrusive measures can be made available via user specific voice prints, etc.

According to exemplary embodiments, user devices 123a-123n may include any suitable customer premise equipment (CPE) capable of exchanging information with platform 101 over communication network(s) 131 via, for example, portal 127. For instance, user devices 123a-123n may include suitable voice terminals (e.g., plain old telephone service (POTS) devices, facsimile machines, etc.), suitable mobile devices (e.g., cellular phones, radiophones, satellite phones, smart phones, wireless phones, or any other suitable mobile device, such as a personal digital assistant (PDA), pocket personal computer, tablet, customized hardware, etc.), and/or suitable computing devices (e.g., VoIP phone, skinny client control protocol (SCCP) phone, session initiation protocol (SIP) phone, IP phone, personal computer, softphone, workstation, terminal, server, etc.). In this manner, communication devices 111 may include any one of user devices 123a-123n that are further capable of telephony communications and include (or have associated therewith) a display for presenting caller ID messages to users. Even though only limited numbers of user devices 123a-123n and communication devices 111 are illustrated, it is contemplated that system 100 can support a plurality of these devices.

As previously mentioned, user profiles repository 125 stores user profiles associated with caller ID-based message receivers and/or message content providers, whereas message content repository 113 includes one or more forms of message content uploaded by message content providers. Even though described as separate entities, repositories 113 and 125 may also be collocated and/or maintained via a common storage facility. In this manner, repositories 113 and 125 may be maintained by a service provider of the caller ID-based messaging services of system 100 and/or by a third-party, such as a business, enterprise, government, institution, organization, etc., associated with the message content. It is contemplated that the physical implementation of repositories 113 and 125 may take on many forms, including, for example, portions of existing repositories of a service provider, new repositories of a service provider, third-party repositories, and/or shared-repositories. As such, repositories 113 and 125 may be configured for communication over system 100 through any suitable messaging protocol, such as lightweight directory access protocol (LDAP), extensible markup language (XML), open database connectivity (ODBC), structured query language (SQL), and the like, as well as combinations thereof. In those instances when repositories 113 and 125 are provided in distributed fashions, information and content available via repositories 113 and 125 may be located utilizing any suitable querying technique, such as electronic number matching, distributed universal number discovery (DUNDi), uniform resource identifiers (URI), directory address association, etc.

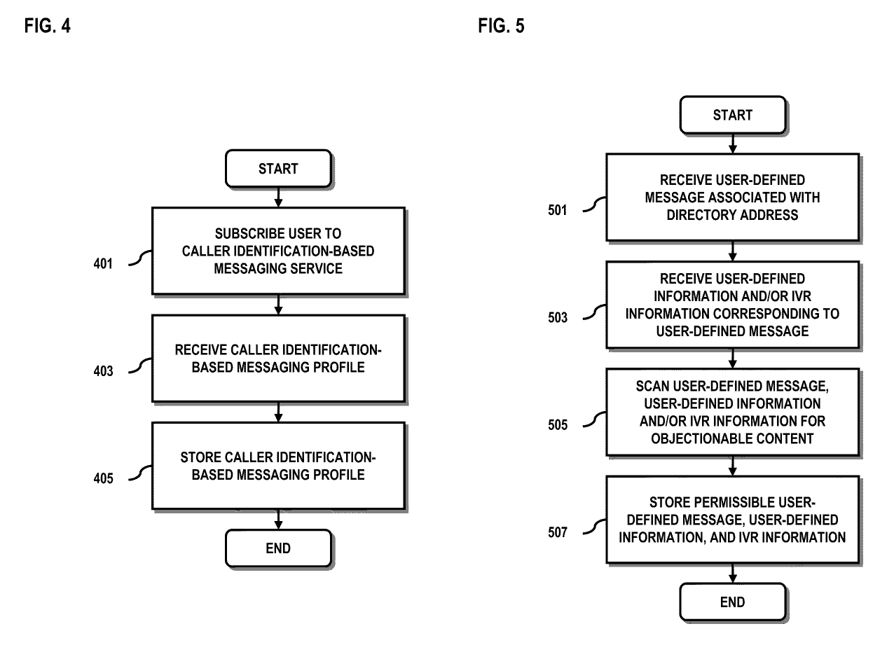

FIG. 4 is a flowchart of a process for generating a caller identification-based messaging profile, according to an exemplary embodiment. For illustrative purposes, the process is described with respect to FIG. 1 and in the context of generating and storing a caller ID-based messaging profile of a caller ID-based message receiver. It is contemplated, however, that the process is also applicable to generating and storing caller ID-based messaging profiles for message content providers. Accordingly, it is noted that the types of user profile information described in association with the process of FIG. 4 corresponds to the category of user and, therefore, it is contemplated that other user profile information may be implicated based on the context of the process. Further, the steps of the process may be performed in any suitable order, as well as combined or separated in any suitable manner. At step 401, platform 101 subscribes a user associated with a communication device, e.g., communication device 111, to the caller ID-based messaging services of system 100. According to one embodiment, the user may subscribe utilizing any suitable user device capable of processing and transmitting information over one or more of communication networks 131, such as user devices 123a-123n. Namely, the user may interact with an input interface (e.g., a keyboard, interactive voice response (IVR) interface, etc.) of, for example, user device 123a to activate software resident on the device, such as a GUI or other networked application that interfaces with or is implemented by platform 101. Alternatively, the user may interact with a voice portal interfacing with or implemented by platform 101, wherein speech synthesis and voice recognition techniques are utilized to prompt the user for various information and to reduce spoken utterances of the user and/or other signals (e.g., dual tone multi-frequency signals) associated with the user to one or more corresponding inputs. As such, the user may be permitted to register as a new subscriber to the caller ID-based messaging services and may obtain sufficient authentication information for establishing future sessions with platform 101. In certain embodiments, registration procedures may prompt the user to identify all user devices that the user may employ to interact with system 100. In this manner, registered devices may be logically associated with the user.

Once registered (or as part of the registration process), platform 101 enables the user, per step 403, to generate a user profile including, for example, addresses of one or more communication devices 111 that the user wants to receive transmitted caller ID-based messages on. These addresses may be specified as one or more directory numbers, electronic serial numbers, international mobile equipment identifiers, machine access control addresses, mobile directory numbers, mobile equipment identities, mobile identification numbers, internet protocol addresses, port addresses, and/or any other suitable address corresponding to one or more of user devices 123a-123n and communication devices 111 for accepting caller ID-based messages (e.g., message 103). The user may be further allowed to create, customize, and manage one or more caller ID-based messaging policies for extending the caller ID-based messaging services to the user. In this manner, the user profile may include some or all of the earlier described user profile information, e.g., username, password, account information, billing information, configuration information, and the like, as well as messaging policy parameters enabling users to opt-in or opt-out of receiving caller ID-based messages from message content providers. Accordingly, these parameters (or criteria) may be specified to govern the who, what, when, where, and how messages are to be received, such as one or more of the aforementioned parameters defining amount, circumstances, frequency, location, mode, subjects, timing, whitelists, blacklists, etc., for receiving caller ID-based messages. As such, platform 101 enables the user to define a user profile that may be utilized to dynamically receive, retrieve, select, and transmit caller ID-based messages (e.g., message 103) to subscribers for presentation via conventional caller ID interfaces, e.g., caller ID interface 109. At step 405, platform 101 stores the caller ID-based messaging profile to, for instance, user profiles repository 125. It is noted that platform 101 may additionally (or alternatively) store or synchronize this information to a storage location or memory of, for instance, platform 101, one or more memories of user devices 123a-123n, communication devices 111, communication session control nodes 115a-115n, and/or any other suitable storage location or memory of (or accessible to) platform 101. Further, it is contemplated that users may directly interact with one or more of these storage facilities, such as user profiles repository 125.

FIG. 5 is a flowchart of a process for receiving and storing caller identification-based messaging content, according to an exemplary embodiment. For illustrative purposes, the process is described with respect to FIG. 1. It is assumed that a message content provider is already a subscriber of the caller ID-based messaging services of system 100 and is authenticated to platform 101. Further, the steps of the process may be performed in any suitable order, as well as combined or separated in any suitable manner. At step 501, platform 101 may receive one or more user-defined messages associated with one or more directory addresses. That is, platform 101 may enable message content providers to create, upload, and manage user-defined messages for transmission to receiving subscribers for presentation via conventional caller ID interface fields, such as corresponding CNAM fields of caller ID interfaces 109. This message content may comprise billing information, emergency information, flight information, group information, meeting information, weather information, stock information, notification information, or any other suitable form of information, such as date and time information, etc. As such, platform 101 may also be configured to receive (in step 503) user-defined information and/or IVR information corresponding to the user-defined messages. That is, platform 101 may enable users to create, upload, and manage user-defined information associated with the user-defined messages that may be transmitted to receiving subscribers via other conventional caller ID interface fields, such as corresponding CNUM fields of caller ID interfaces 109. The IVR information may be utilized to populate one or more IVR systems, such as IVR system 233, the purpose of which will become more readily apparent below. In exemplary embodiments, received user-defined messages, information, and/or IVR information may be scanned (per step 505) for objectionable content, as previously described in association with FIG. 1. Thus, in step 507, permissible caller ID-based message content may be stored to one or more message content repositories, e.g., message content repository 113, for retrieval by communication session control nodes 115a-119n to “push” (or otherwise transmit) the user-defined message content to receiving subscribers, as will become more apparent in association with the discussion of FIG. 7.

As will be described in more detail below, received user-defined message content may be stored to one or more message content repositories (e.g., message content repository 113) based on (or in association with) various messaging attributes, such as in association with one or more destination directory addresses, one or more originating directory addresses, and/or associated user-defined information. Accordingly, platform 101 enables message content providers to create, upload and manage message content that is to be dynamically retrieved and transmitted to intended subscribers.

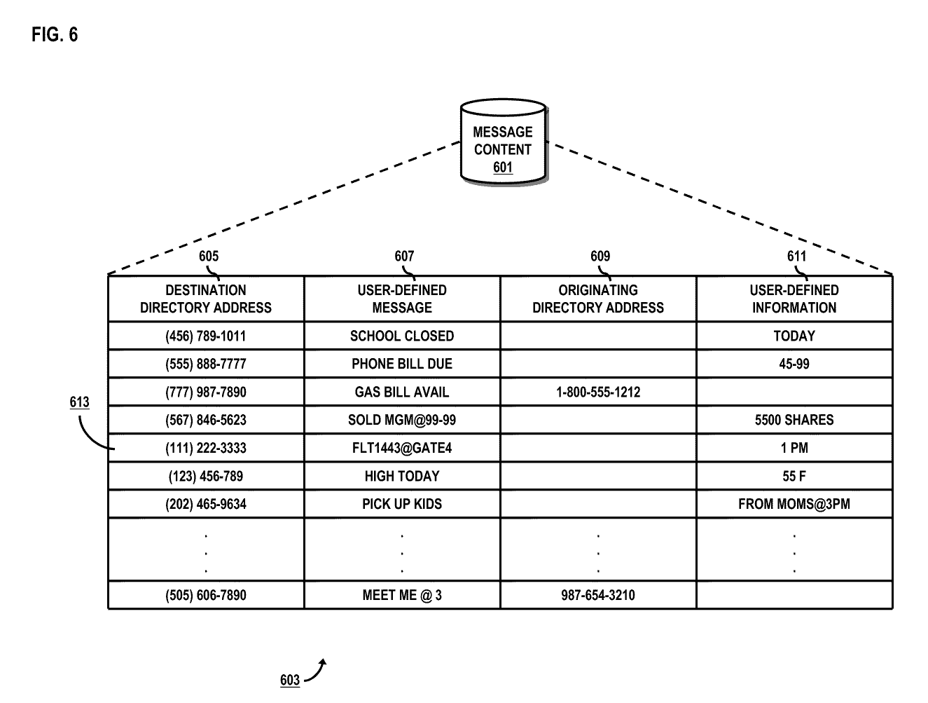

FIG. 6 is a diagram of user-defined message content stored in association with one or more messaging attributes, according to an exemplary embodiment. As shown, message content repository 601 includes a plurality of messaging records 603 for generating and transmitting user-defined messages to subscribers via conventional caller ID interfaces, such as caller ID interface 109. In this manner, messaging records 603 may be stored to message content repository 601 according to one or more structured models, such as according to a relational database model. In this manner, user-defined messages may be stored in association with one or more messaging attributes, such as in association with one or more directory addresses and/or other user-defined information. That is, individual messaging records 603 may include a plurality of attribute fields, such as a destination directory address field 605, a user-defined message field 607, an originating directory address field 609, and a user-defined information field 611, as well as any other suitable field, such as one or more policy-based fields, subject matter category fields, and the like. For example, messaging record 613 corresponds to a flight information/notification message, wherein user-defined message “FLT1443@GATE4” is associated with other user-defined information, e.g., “1 PM” and intended for a subscriber corresponding to destination directory address “(111) 222-3333.” Accordingly, when a communication session control node, such as communication session control node 119n, queries one or more message content repositories (e.g., message content repository 601) for user-defined messages, these message content repositories may provide messaging records 603 or attributes of messaging records 603.

FIG. 7 is a flowchart of a process for providing caller identification-based messages to subscribers, according to an exemplary embodiment. For illustrative purposes, the process is described with respect to FIGS. 2, 3, and 6. It is noted that the process assumes implementation in an otherwise unconventional manner, i.e., not in response to a calling party seeking to establish a communication session (e.g., telephony call) with a called party, but in accordance with user-defined message content having been uploaded to a networked message content repository (e.g., message content repository 113) by a message content provider seeking to “push” the uploaded user-defined message to a subscriber having a conventional caller ID interface, such as caller ID interface 109, during establishment of a communication session with, for instance, communication device 111 that is initiated by, for example, a communication session control node, e.g., node 300. Even still, it is also contemplated that the process is capable of implementation in conventional caller ID provisioning scenarios, such as when a calling party attempts to establish a communication session (e.g., telephony call) with a called party and, as a result, caller ID information is presented to the called party during establishment of the communication session between the calling and called parties. It is noted, however, that instead of conveying conventional CNAM and CNUM information, the process conveys unconventional caller ID information, i.e., user-defined messages and/or other information associated with the user-defined messages via conventional caller ID fields, e.g., CNAM and CNUM fields, of a caller ID message. Further, the steps of the process may be performed in any suitable order, as well as combined or separated in any suitable manner.

At step 701, communication session control node 300 via, for instance, querying module 311 queries one or more networked message content repositories, such as message content repository 601, for user-defined messages. This query may be performed continually, periodically, randomly, or in an “on-demand” fashion. In response to querying, for instance, message content repository 601, node 300 receives (per step 703) at least one messaging record including user-defined message content associated with one or more intended recipients, e.g., one or more directory addresses associated with the one or more intended recipients. The user-defined message content may comprise a user-defined message and/or other information associated with the user-defined message. By way of example, node 300 may receive messaging record 613 including user-defined message “FLT1443@GATE4” and other information associated with the user-defined message, i.e., “1 PM.” This user-defined message content is intended to be “pushed” or otherwise transmitted to a subscriber associated with directory address “(111) 222-3333” for presentation via conventional caller ID interface 109 of or associated with communication device 111 during establishment of a communication session with communication device 111. Even though not illustrated, network repositories, such as message content repository 601, responding to querying module 311 with messaging records may additionally provide one or more IVR systems (e.g., IVR system 233) with IVR content (e.g., audible prompts, options, information, etc.) that may also be stored in association with these messaging records, the purpose of which will become more apparent below. In any event, querying module 311 may provide message generation module 313 with result(s) of the querying or may parse the results and, thereby, provide message generation module 313 with certain caller ID information, such as the aforementioned user-defined message and user-defined information. Accordingly, at step 705, message generation module 313 creates a conventional caller ID message, however, inserts (or otherwise populates) the user-defined message as a CNAM field and the user-defined information as a CNUM field of the caller ID message, which is more readily understood with reference to FIG. 8.

FIG. 8 is a diagram of a caller identification message, according to an exemplary embodiment. As depicted, caller ID message 801 may be configured to comprise one or more fields, such as CNAM field 803 and CNUM field 805. In an unconventional manner, however, CNAM field 803 may be populated by user-defined message 807 instead of conventional CNAM information. This user-defined message may relate to or comprise billing information, emergency information, flight information, group information, meeting information, weather information, stock information, notification information, or any other suitable form of information. Similarly, CNUM field 805 may comprise associated information 809, such as user-defined information associated with user-defined message 807 instead of conventional CNUM information. It is noted, however, that associated information 809 may include a “call back” or “associated” directory address corresponding to an originator of the user-defined message. In this manner, caller ID message 801 may also include one or more other fields, such as fields 811a-811n, comprising various forms of conventional caller ID information, such as date and time information. It is noted, however, that this date and time information may relate to the user-defined message or may relate to establishment of a communication session for “pushing” or otherwise transmitting caller ID message 801 to an intended recipient during the establishment of the communication session.

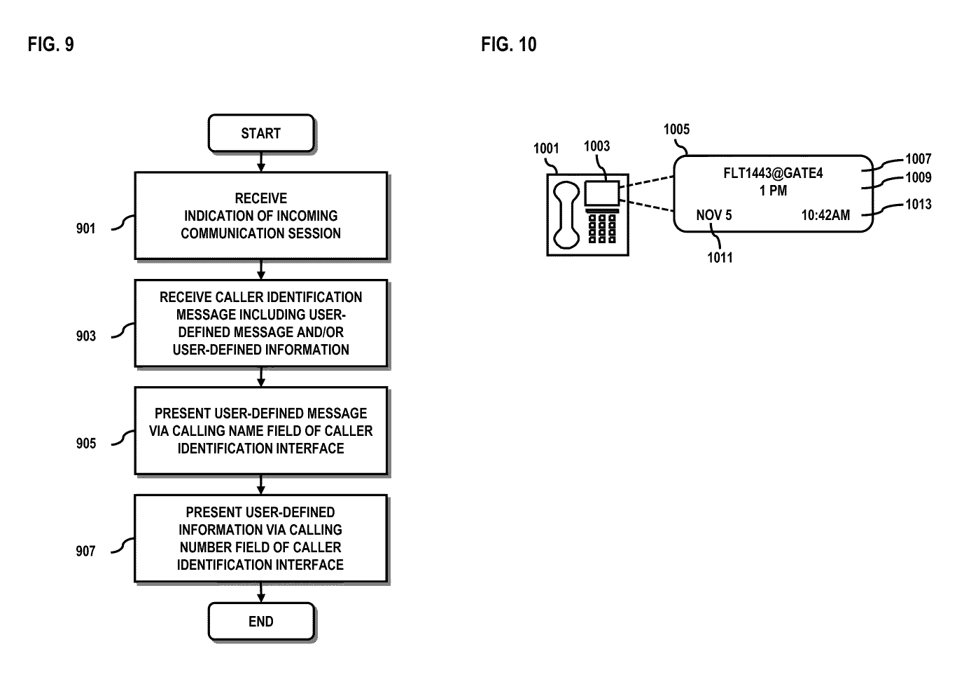

Referring back to FIG. 7, node 300 via, for instance, communication session module 301 initiates (in step 707) a communication session (e.g., a telephony call) with a communication device corresponding to the aforementioned directory address associated with the user-defined message. Namely, communication session module 301 signals, for example, communication device 111 to cause communication device 111 to present one or more alert signals during alerting intervals of the establishment of the communication session. In exemplary embodiments, node 300 may be configured, via communication interface 303, to transmit, in step 709, the generated caller ID message to communication device 111 for presentation of the user-defined message and the user-defined information via a conventional caller ID interface 109 of (or associated with) communication device 111. This transmission may occur before, during, or after one or more alerting intervals, such as during a first “silent” interval after a first “ringing tone” interval. An exemplary process for presenting received caller ID-based messages via a caller ID interface is described in more detail in association with FIG. 9.

At step 711, communication session control node 300 via, for instance, monitoring module 309 may be configured to monitor for an answering, staffing, or picking up of the communication session at communication device 111. That is, monitoring module 309 may be configured to monitor for an “off hook” state associated with communication device 111 and the establishment of the communication session. Accordingly, per step 713, monitoring module 309 determines whether the communication session has been answered. If the communication session is not answered, communication session module 301 may be configured to terminate (in step 715) the establishment of the communication session after a predefined number of alerting signals have been caused to be presented in association with the establishment of the communication session. For instance, the communication session may be terminated after two or more ringing alerts have been caused to be presented in association with the establishment of the communication session. If, however, monitoring module 309 detects that the communication session has been answered, communication session module 301 may connect, at step 717, the aforementioned IVR system (e.g., IVR system 233) that may have been populated with IVR content, which may also have been user-defined and stored in association with the user-defined messaging content. As such, IVR system 233 may be configured to present an audio interface (or any other voice portal) for audibly conveying the user-defined message and/or user-defined information and/or presenting one or more prompts, options, etc., associated with the user-defined message.

FIG. 9 is a flowchart of a process for presenting caller identification-based messages, according to an exemplary embodiment. For illustrative purposes, the process is described with respect to FIGS. 1 and 8. It is also noted that the steps of the process may be performed in any suitable order, as well as combined or separated in any suitable manner. At step 901, communication device 111 receives an indication (e.g., alerting ring) of an incoming communication session. In step 903, communication device 111 receives a caller ID message including a user-defined message, user-defined information, and/or conventional CNUM information from, for example, communication session control node 119n. It is noted that the caller ID message may be received before, during, or after any suitable “silent” or alerting (e.g., “ringing tone”) interval, such as during a first “silent” interval proceeding a first “ringing tone” interval. In exemplary embodiments, caller ID messages (such as caller ID message 801) contain user-defined messages in CNAM fields (such as CNAM field 803) and user-defined information and/or conventional CNUM information in CNUM fields (such as CNUM field 805). At step 905, conventional caller ID interface 109 presents the received user-defined message via a corresponding CNAM field of caller ID interface 109. In step 907, conventional caller ID interface 109 presents the received user-defined information via a corresponding CNUM field of caller ID interface 109. An exemplary caller ID-based messaging presentation is described in more detail in conjunction with FIG. 10.

FIG. 10 is a diagram of a caller identification-based message presented via a conventional caller identification interface, according to an exemplary embodiment. By way of example, communication device 1001 may be a POTS device including a display 1003 that is configured to present conventional caller ID information to subscribers. That is, display 1003 may be configured to present (e.g., display) CNAM, CNUM, date, and/or time information via one or more conventional caller ID fields, such as CNAM field 1007, CNUM field 1009, date field 1011, and time field 1013. Unconventionally, however, CNAM field 1007 and CNUM field 1009 may be respectively populated with a user-defined message and associated user-defined information associated with the user-defined message. Namely, CNAM field 1007 may present user-defined message “FLT1443@GATE4” instead of a name associated with a calling party, whereas CNUM field 1009 may present user-defined information “1 PM” that is associated with the user-defined message instead of a number associated with a calling party. It is noted that this unconventional CNAM and CNUM information may be “pushed” to communication device 1001 during establishment of a communication session initiated by, for instance, a communication session control node (e.g., communication session control node 119n) of service provider environment 107. In other instances, this unconventional CNAM and CNUM information may be provided in a conventional manner when, for instance, a communication session initiating party attempts to establish communications with a communication session receiving party. Furthermore, this CNAM and CNUM information may be configured to override caller ID information stored to (or in association with) communication device 1001. It is also noted that date field 1011 and time field 1013 may continue to provide conventional date and time information, however, it is contemplated that these fields may be populated with various user-defined content or may relate to the user-defined message as opposed to a communication session utilized to transmit the user-defined message to communication device 1101.

The processes described herein for providing caller ID-based messaging services may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 11 illustrates computing hardware (e.g., computer system) 1100 upon which an embodiment according to the invention can be implemented. The computer system 1100 includes a bus 1101 or other communication mechanism for communicating information and a processor 1103 coupled to the bus 1101 for processing information. The computer system 1100 also includes main memory 1105, such as a random access memory (RAM) or other dynamic storage device, coupled to the bus 1101 for storing information and instructions to be executed by the processor 1103. Main memory 1105 can also be used for storing temporary variables or other intermediate information during execution of instructions by the processor 1103. The computer system 1100 may further include a read only memory (ROM) 1107 or other static storage device coupled to the bus 1101 for storing static information and instructions for the processor 1103. A storage device 1109, such as a magnetic disk or optical disk, is coupled to the bus 1101 for persistently storing information and instructions.

The computer system 1100 may be coupled via the bus 1101 to a display 1111, such as a cathode ray tube (CRT), liquid crystal display, active matrix display, or plasma display, for displaying information to a computer user. An input device 1113, such as a keyboard including alphanumeric and other keys, is coupled to the bus 1101 for communicating information and command selections to the processor 1103. Another type of user input device is a cursor control 1115, such as a mouse, a trackball, or cursor direction keys, for communicating direction information and command selections to the processor 1103 and for controlling cursor movement on the display 1111.

According to an embodiment of the invention, the processes described herein are performed by the computer system 1100, in response to the processor 1103 executing an arrangement of instructions contained in main memory 1105. Such instructions can be read into main memory 1105 from another computer-readable medium, such as the storage device 1109. Execution of the arrangement of instructions contained in main memory 1105 causes the processor 1103 to perform the process steps described herein. One or more processors in a multi-processing arrangement may also be employed to execute the instructions contained in main memory 1105. In alternative embodiments, hard-wired circuitry may be used in place of or in combination with software instructions to implement the embodiment of the invention. Thus, embodiments of the invention are not limited to any specific combination of hardware circuitry and software.

The computer system 1100 also includes a communication interface 1117 coupled to bus 1101. The communication interface 1117 provides a two-way data communication coupling to a network link 1119 connected to a local network 1121. For example, the communication interface 1117 may be a digital subscriber line (DSL) card or modem, an integrated services digital network (ISDN) card, a cable modem, a telephone modem, or any other communication interface to provide a data communication connection to a corresponding type of communication line. As another example, communication interface 1117 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1117 sends and receives electrical, electromagnetic, or optical signals that carry digital data streams representing various types of information. Further, the communication interface 1117 can include peripheral interface devices, such as a Universal Serial Bus (USB) interface, a PCMCIA (Personal Computer Memory Card International Association) interface, etc. Although a single communication interface 1117 is depicted in FIG. 11, multiple communication interfaces can also be employed.

The network link 1119 typically provides data communication through one or more networks to other data devices. For example, the network link 1119 may provide a connection through local network 1121 to a host computer 1123, which has connectivity to a network 1125 (e.g. a wide area network (WAN) or the global packet data communication network now commonly referred to as the “Internet”) or to data equipment operated by a service provider. The local network 1121 and the network 1125 both use electrical, electromagnetic, or optical signals to convey information and instructions. The signals through the various networks and the signals on the network link 1119 and through the communication interface 1117, which communicate digital data with the computer system 1100, are exemplary forms of carrier waves bearing the information and instructions.

The computer system 1100 can send messages and receive data, including program code, through the network(s), the network link 1119, and the communication interface 1117. In the Internet example, a server (not shown) might transmit requested code belonging to an application program for implementing an embodiment of the invention through the network 1125, the local network 1121 and the communication interface 1117. The processor 1103 may execute the transmitted code while being received and/or store the code in the storage device 1109, or other non-volatile storage for later execution. In this manner, the computer system 1100 may obtain application code in the form of a carrier wave.

The term “computer-readable medium” as used herein refers to any medium that participates in providing instructions to the processor 1103 for execution. Such a medium may take many forms, including but not limited to non-volatile media, volatile media, and transmission media. Non-volatile media include, for example, optical or magnetic disks, such as the storage device 1109. Volatile media include dynamic memory, such as main memory 1105. Transmission media include coaxial cables, copper wire and fiber optics, including the wires that comprise the bus 1101. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving a user-defined message associated with a directory address of a communication device;
inserting the user-defined message into a caller name identification field of a caller identification message;
initiating establishment of a communication session with the communication device; and
transmitting the caller identification message to the communication device for presentation of the user-defined message during establishment of the communication session.

2. A method according to claim 1, further comprising:
querying, periodically, a networked repository for user-defined messages,
wherein the user-defined message is received in response to querying.

3. A method according to claim 2, wherein one or more user-defined messages are stored to the networked repository based on user profile information associated with a user of the communication device.

4. A method according to claim 1, wherein the caller identification message is pushed to the communication device.

5. A method according to claim 1, further comprising:
monitoring for answer of the communication session.

6. A method according to claim 5, further comprising:
connecting, if the communication session is answered, an interactive voice response system to the communication session,
wherein the interactive voice response system presents an audio interface for audibly conveying the user-defined message, one or more options associated with the user-defined message, or a combination thereof.

7. A method according to claim 5, further comprising:
causing one or more alerting signals to be presented in association with the establishment of the communication session; and
terminating, if the communication session is not answered, the establishment of the communication session after a predefined number of alerting signals have been caused to be presented.

8. A method according to claim 1, wherein the caller identification message further includes a caller identification number field, the method further comprising:
receiving user-defined information corresponding to the user-defined message; and
inserting the user-defined information into the caller identification number field,
wherein the user-defined information is presented along with the user-defined message during establishment of the communication session.

9. A method according to claim 1, wherein the user-defined message includes billing information, date information, emergency information, flight information, group information, meeting information, time information, weather information, or a combination thereof.

10. A method according to claim 1, wherein the caller identification message overrides caller identification information stored to the communication device.

11. An apparatus comprising:
at least one processor; and
at least one memory including computer program code, the at least one memory and the computer program code configured, with the at least one processor, to cause the apparatus at least to:
receive a user-defined message associated with a directory address of a communication device,
insert the user-defined message into a caller identification field of a caller identification message,
initiate establishment of a communication session with the communication device,
transmit the caller identification message to the communication device for presentation of the user-defined message during establishment of the communication session.

12. An apparatus according to claim 11, wherein the apparatus is at least further caused to:
query, periodically, a networked repository for user-defined messages,
wherein the user-defined message is received in response to querying.

13. An apparatus according to claim 12, wherein one or more user-defined messages are stored to the network repository based on user profile information associated with a user of the communication device.

14. An apparatus according to claim 11, wherein the caller identification message is pushed to the communication device by the apparatus.

15. An apparatus according to claim 11, wherein the apparatus is at least further caused to:
monitor for answer of the communication session.

16. An apparatus according to claim 15, wherein the apparatus is at least further caused to:
connect, if the communication session is answered, an interactive voice response system to the communication session,
wherein the interactive voice response system presents an audio interface for audibly conveying the user-defined message, one or more options associated with the user-defined message, or a combination thereof.

17. An apparatus according to claim 15, wherein the apparatus is at least further caused to:
cause one or more alerting signals to be presented in association with the establishment of the communication session; and
terminate, if the communication session is not answered, the establishment of the communication session after a predefined number of alerting signals have been caused to be presented.

18. An apparatus according to claim 11, wherein the caller identification message further includes a caller identification number field and the apparatus is at least further caused to:
receive user-defined information corresponding to the user-defined message; and
insert the user-defined information into the caller identification number field,
wherein the user-defined information is presented along with the user-defined message during establishment of the communication session

19. An apparatus according to claim 11, wherein the user-defined message includes billing information, date information, emergency information, flight information, group information, meeting information, time information, weather information, or a combination thereof.

20. An apparatus according to claim 11, wherein the caller identification message overrides caller identification information stored to the communication device.
